(19) United States
(12) Patent Application Publication
(10) Pub. No.: US 2026/0176520 A1
(43) Pub. Date: Jun. 25, 2026

(54) CHEMICAL METHODS FOR CAVITATION INCEPTION IN DOWNHOLE ENVIRONMENTS

(71) Applicant: SAUDI ARABIAN OIL COMPANY, Dhahran (SA)

(72) Inventors: Madina Baltaeva, Moscow (RU); Maxim Orlov, Moscow (RU); Timur Zharnikov, Moscow (RU); Valery Andreev, Moscow (RU); Abdullah S. Al-Yami, Dhahran (SA); Vikrant Wagle, Abqaiq (SA)

(73) Assignees: Aramco Innovations LLC, Moscow (RU); SAUDI ARABIAN OIL COMPANY, Dhahran (SA)

(21) Appl. No.: 18/832,593

(22) PCT Filed: Oct. 20, 2023
(86) PCT No.: PCT/RU2023/000320

§ 371 Date: Jul. 24, 2024

(51) Int. Cl. C09K 8/38; B01J 13/12; B01J 13/18; C09K 8/035; C09K 8/512; C09K 8/518; E21B 21/00; E21B 21/06

(52) U.S. Cl. CPC C09K 8/38; B01J 13/125; B01J 13/185; C09K 8/035; C09K 8/512; C09K 8/518; E21B 21/003; E21B 21/062; C09K 2208/10

(57) ABSTRACT

A method of introducing cavitation downhole includes creating cavitation nuclei, introducing cavitation nuclei to a drilling fluid, delivering the drilling fluid downhole, and activating an acoustic source downhole. A method of preventing lost circulation includes introducing cavitation nuclei downhole, introducing lost circulation materials downhole where the lost circulation materials include a resin and microcapsules of a crosslinking agent, activating an acoustic source which may induce cavitation; and rupturing the microcapsule of the crosslinking agent to prevent lost circulation.

### BACKGROUND

Cavitation processes are widely used in medical treatment and chemical engineering. Cavitation can occur either naturally, for example, on the surface of ship's propeller blades, or it can be created intentionally, for example, by using a high-power acoustic source. Typically, cavitation is observed and used at relatively low pressures up to several atm. The reason is that the cavitation threshold rapidly increases with the rise of the ambient pressure. However, in some cases, for example, in the oil and gas industry, it is of interest to induce the cavitation at high pressures (e.g., at tens and hundreds of atm) that exist downhole. One of the associated challenges is that the cavitation threshold rapidly increases with increasing pressure, which makes it progressively difficult to induce the cavitation at high pressures.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method of inducing cavitation downhole. The method may include creating cavitation nuclei, introducing cavitation nuclei to a drilling fluid, delivering the drilling fluid downhole, and activating an acoustic source downhole.

In another aspect, embodiments disclosed herein relate to a method of preventing lost circulation. The method may include introducing cavitation nuclei downhole, introducing lost circulation materials downhole where the lost circulation materials include a resin and microcapsules of a crosslinking agent, activating an acoustic source which may induce cavitation; and rupturing the microcapsules of the crosslinking agent to prevent lost circulation.

Other aspects and advantages of the claimed subject matter will be apparent from the following description and the appended claims.

### BRIEF DESCRIPTION OF DRAWINGS

FIG. 1 is a diagram that illustrates a well environment with a treatment system in accordance with one or more embodiments.

FIG. 2 is a depiction of a porous nanoparticle in accordance with one or more embodiments.

FIG. 3 is a depiction of a microcapsule in accordance with one or more embodiments.

FIG. 4 is a depiction of a gas generating system in accordance with one or more embodiments.

FIG. 5 is a depiction of a stabilized fluid in accordance with one or more embodiments.

### DETAILED DESCRIPTION

In the field of medical treatment and chemical engineering, the concept of creating cavitation nuclei and delivering them to a cavitation inception location is known. For example, it is used to induce the cavitation at a target location. Such an approach is very attractive from the point of view of wellbore operations. The present disclosure relates to a system and a method for cavitation inception at high pressures, and specifically in wellbore environments.

In one aspect, embodiments disclosed herein relate to a method of treating a well environment. The method includes creating cavitation nuclei, introducing cavitation nuclei to a drilling fluid, delivering the drilling fluid downhole, and activating an acoustic device downhole thereby inducing cavitation downhole. Cavitation nuclei described herein may be various different types of nuclei and they may be created via a variety of techniques. The cavitation nuclei may be uniquely capable of withstanding downhole environments, including elevated temperature and pressure. As such, the cavitation nuclei may be particularly useful for treating downhole environments in a specific and targeted manner.

### Well Environment

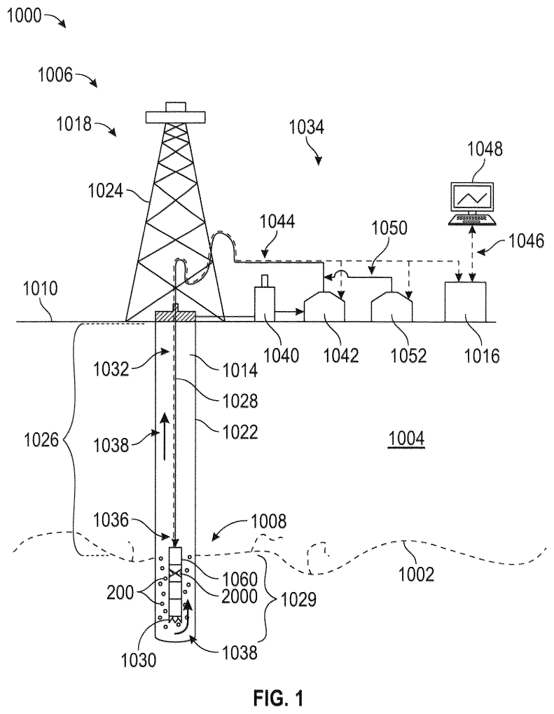

FIG. 1 is a diagram that illustrates a well environment with a treatment system in accordance with one or more embodiments. In FIG. 1, the well environment 1000 includes a lost circulation zone 1002 located among the subsurface formations 1004. Well system 1006 is shown traversing subsurface formation 1004 and is in fluid communication with lost circulation zone (LCZ) 1002 through lost circulation zone face 1008. While the present disclosure focuses on the application of curing lost circulation with the cavitation nuclei, as will be appreciated by those skilled in the art, the cavitation nuclei may be used for a variety of downhole applications. Cavitation nuclei may also initiate cavitation which leads to the activation of microcapsules with a crosslinking agent to polymerize an active medium in water/gas shut-off operations. Isolation squeeze operations arm another way to use cavitation nuclei for cavitation inception at high static pressures.

Subsurface formations 1004 may include one or more porous or fractured rock formations that reside beneath the surface 1010. The surface 1010 may be dry land or ocean bottom. Well system 1006 may be formed for the purposes of developing a hydrocarbon well, such as an oil well, a gas well, a gas condensate well, a mixture thereof, or another type of well, such as a fresh, brine, or mineral water well. The subsurface formations 1004 and the lost circulation zone 1002 may each have heterogeneity with varying characteristics, such as degree of density, permeability, porosity, pressure, temperature, and fluid saturations of the rock within each formation.

In the instance of the well system 1006 intending to be operated as a production well, the well system 1006 may facilitate the extraction of hydrocarbons (or “production”) from a reservoir or otherwise hydrocarbon-bearing formation. In the case of the well system 1006 being operated as an injection well, the well system 1006 may facilitate the injection of fluids into the subsurface formations 1004. In the case of the well system 1006 being operated as a monitoring well, the well system 1006 may facilitate the monitoring of various characteristics of the subsurface formations 1004, such as pressure or saturation of a particular formation.

The well system 1006 may include a wellbore 1014, a well control system (or “control system”) 1016, and a drilling system 1018. The control system 1016 may regulate various operations of the well system 1006, such as well drilling operations, well completion operations, well production operations, or well or formation monitoring operations.

The wellbore 1014 may include a bored hole that extends from the surface 1010 into the subsurface formations 1004 such that fluid communication is established with the lost circulation zone 1002. Wellbore 1014 is a void that is defined by wellbore wall 1022. Although shown as a vertical well, the configuration of the wellbore 1014 may also be deviated, approximately horizontal or horizontal, and combinations thereof, as a person of ordinary skill in the art well appreciates. The one or more embodiments are adaptable and applicable to all wellbore configurations.

The wellbore 1014 may be created, for example, by the drilling system 1018 boring through the subsurface formation 1004. In one or more embodiments, the drilling system 1018 includes a drilling rig 1024 supporting and manipulating a drill string 1026. The drill string 1026 may include drill pipe 1028 with a bottom hole assembly (BHA) 1029 coupled to the distal end of the drill pipe 1028. Drill pipe 1028 may also include drill collars. A drill bit 1030, which features members that can bore through the subsurface formations 1004 to form the wellbore 1014, is part of and attached to the distal end of the drill string 1026.

In one or more embodiments, the treatment system comprises a treatment sub as a component of a drill string. As shown in FIG. 1 treatment sub 2000 is shown as pan of BHA 1029 upstring of drill bit 1030. As part of the BHA, the treatment sub may be positioned similarly as a logging while drilling (LWD) or measurement while drilling (MWD) tool would be positioned as a person of skill in the art would appreciate. The treatment sub may be positioned along the BHA proximate to the drill bit to provide for an expedient response to detection and treatment of a lost circulation zone. However, in doing so, one of skill may recognize that structures such as shock collar or other impact-deflecting or absorbing coupling between the treatment sub and the drill bit may be appropriate to protect the sonic frequency generation sources that are part of the treatment sub, as will be described further.

Treatment sub 2000 in FIG. 1 is shown physically positioned proximate to and downhole of the lost circulation zone face 1008 such that a treatment may be applied. Such physical positioning versus the face of the LCZ may depend on a number of factors, such as, but not limited to, the physical configuration of the treatment sub and the BHA, the location of the face of the lost circulation zone, the sonic source configuration, that is, the direction in which the generated sonic frequency forms, and how the cavitation nuclei are introduced into the wellbore fluid.

In one or more embodiments, the treatment sub is positioned upstream of the face of the lost circulation zone. “Upstream” in this sense is relative to the circulation pathway of wellbore fluid. Being positioned upstream based upon the flow of the wellbore fluid permits the treatment sub to initiate a treatment, such as generation of a sonic frequency, such that the lost circulation material (LCM) forms before or within the face of the LCZ. If wellbore fluid is circulating downhole through the drill pipe 1028 and uphole in a wellbore annulus 1036, such as shown in FIG. 1, the treatment sub 2000 may be positioned downhole of the lost circulation zone face 1008. The wellbore annulus 1036 is the wellbore 1014 void between the drill string 1026 and the wellbore wall 1022. The wellbore fluid is shown in FIG. 1 flowing 1038 in part through drill bit 1030 and uphole via wellbore annulus 1036. Counter, if the wellbore fluid is circulating downhole through the wellbore annulus, the treatment sub may be positioned uphole of the face of the lost circulation zone. In such an instance, formed LCM would traverse downflow and downhole to the LCZ through the wellbore annulus.

The mud circulation system 1034 is pan of drilling system 1018 and serves a number of useful functions during operations, as one of ordinary skill in the an appreciates. A wellbore fluid 1032, such as a drilling fluid or “mud”, circulates in the wellbore 1014 during drilling operations (as well as other types of operations as previously described). The wellbore fluid 1032 typically flows downhole through an internal fluid conduit of the drill string 1026 (as will be described further), out the drill bit 1030, and back uphole through the wellbore annulus 1036. Cuttings and other drilling debris are conveyed from the bottom of the wellbore 1014 uphole. In one or more embodiments, the flow pathway is reversed as previously described.

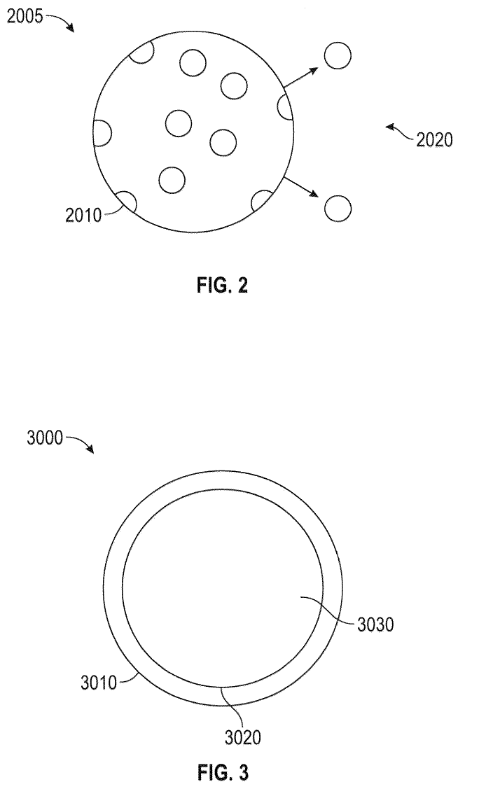

In FIG. 1, several cavitation nuclei 200 (further described as part of FIGS. 2-5) are shown emerging from the drill string 1026 at drill bit 1030, circulating into the wellbore annulus 1036 along wellbore fluid flow 1038 (arrow) and moving uphole towards the lost circulation zone face 1008. As the cavitation nuclei 200 traverse uphole, the cavitation nuclei 200 are shown passing proximate to the treatment sub 2000.

In FIG. 1, the treatment sub in the BHA may be configured with a container sub independent of the treatment sub. In one or more embodiments, the container sub may be used to deliver cavitation nuclei in the BHA such that the container sub is a delivery sub 1060. In one or more embodiments, the delivery sub may contain cavitation nuclei. In such embodiments, the cavitation nuclei ay be released from the delivery sub to desired LCZs from the BHA.

Upon reaching the surface 1010, the wellbore fluid 1032 passes into mud receiving tank 1040, where the cuttings and dissolved gases are separated from the wellbore fluid 1032. The degassed wellbore fluid 1032 passes into the mud storage tank 1042, where the wellbore fluid is held until it is pumped back into the drill string 1026. The mud return line 1044, coupled to the mud storage tank 1042 and the drill string 1026, provides the fluid conduit for the wellbore fluid to start the mud circulation cycle again.

Shown in FIG. 1 coupled to mud return line 1044 is an optional cavitation nuclei injection line 1050. Cavitation nuclei injection line 1050 fluidly couples optional cavitation nuclei storage tank 1052 to mud return line 1044 such that cavitation nuclei, such as those shown in FIG. 1 as cavitation nuclei 200, may be selectively introduced into the mud circulation system 1034 at the surface 1010.

In one or more embodiments, a well control system 1016 may use information obtained from the operations of the drilling system 1018 in conjunction with a set of pre-determined instructions and algorithms retained in a memory of a computer system to maintain or modify operations of the drilling system 1018, such as the operation of the drill bit 1030 or the treatment sub 2000. In FIG. 1, command signals for maintaining or modifying operations of the drilling system 1018, such as components of the BHA 1029, may be transmitted downhole from well control system 1016 via a control signal line 1046 (dotted line). The well control system 1016 may also maintain or modify operations of the mud circulation system 1034. Control signal lines 1046 may interlink the well control system 1016 with support units for the mud storage tank 1042 and the optional cavitation nuclei storage tank 1052, for example, to circulate wellbore fluid and to introduce cavitation nuclei into the wellbore fluid, respectively.

The well, control system 1016 may be coupled to a control terminal 1049 to relay information for viewing by an external viewer. The information may be numerically displayed, graphically displayed, or both. An external viewer may include a computer monitor, a television, a printer, or any other form of temporal or permanent version of record keeping, communicating, and displaying that can be visually and audibly appreciated.

Supporting equipment for embodiments of the system may include additional standard components or equipment that enables and makes operable the described apparatuses, processes, methods, systems, and compositions of matter Examples of such standard equipment known to one of ordinary skill in the art includes, but are not limited to, heat exchanges, blowers, single and multi-stage compressors and pumps, separation equipment, manual and automated control and isolation valves, switches, analogue and computer-based controllers, and pressure-, temperature-, level- flow-, and other-sensing devices.

### Cavitation Nuclei

As noted above, in one or more embodiments described herein, a method includes creating cavitation nuclei. As used herein, “cavitation nuclei” refers to centers or “nuclei” that will eventually undergo cavitation downhole. Essentially, cavitation nuclei are cavitation precursors that can be activated by an external stimulus to cause a cavitation event. Cavitation occurs when the static pressure of a liquid reduces below the liquid's vapor pressure, which leads to the formation of small vapor-filled cavities (or bubbles) in the liquid. When subjected to a suitably high pressure, the cavities collapse and can generate shock waves, i.e., cavitation. Different types of cavitation nuclei may be created according to one or more embodiments of the present disclosure. In particular, the cavitation nuclei may be porous nanoparticles or microcapsules, or they may be generated in a gas generating system, or a foam, as explained in greater detail below. Furthermore, different synthetic methods may be used to create the nuclei in order to achieve different material properties of the nuclei. The method of making the cavitation nuclei may result in a different size, a different stability in downhole conditions, and a different loading in the system. The preferred method depends on the wellbore pressure and temperature and the fluids used during drilling or workover operations. Additionally, the cavitation nuclei may be stabilized by a stabilized fluid. As such, the methods described herein result in a diverse catalogue of cavitation nuclei suitable for downhole environments.

The cavitation nuclei in accordance with one or more embodiments contain a gas or a gas precursor. The gas or gas precursor may serve as a source of bubbles for cavitation. The bubbles may have a diameter in the range from 200 nm to 100 μm. In embodiments in which the cavitation nuclei contain a gas, the gas may be air, CO₂ or N₂. The choice of gas may affect the size of bubbles produced. For example, CO₂ is known to have a larger capacity for diffusion in water-based media. Thus, bubbles with CO₂ may provide a higher surface area. Further, the choice of gas may affect the response to the external stimulus to cause cavitation. It is known that different gases have different solubilities in various mediums. The solubility of the gases may lead to an altered response to the external stimulus and thereby an altered cavitation.

Instead of containing a gas, the cavitation nuclei may contain a gas precursor. A gas precursor is a compound that is configured to form a gas in downhole environments. In one or more embodiments, the gas precursor may be a temperature activated compound where the gas precursor changes phase from a liquid to a gas at an activation temperature. The activation temperature occurs at the boiling point of the gas precursor. The activation temperature may range from 10° C. to 120° C. The gas precursor may be selected based on the wellbore temperature downhole, where the wellbore temperature downhole may be equal to or greater than the activation temperature. The gas precursor may be selected from the group consisting of perfluoropropane; perfluorobutane; perfluoropentane; perfluorohexane; perfluorocyclobutene; perfluoro-1-butene; perfluoro-2-butene; perfluoro-2-butyne; perfluoropropylene, cyclobutane; methyl-cyclobutane; 3-chloro-cyclopentene; cyclopropane; 1,2-dimethyl-cyclopropane; 1,1-dimethyl cyclopropane; 1,2-dimethyl cyclopropane; ethyl cyclopropane; methyl cyclopropane; hexafluoro-dimethyl amine; dimethylethylamine; perfluorodimethylamine; 1,2-difluoro ethane; perfluoro ethylamine; ethyl vinyl ether; 1,1-dichloroethylene; 1,2-difluoroethylene; 1,1-dichloro-1,2-difluoro ethylene; 2-methylbutane; methyl ether; methyl isopropyl ether; methyl lactate; methyl vinyl ether; 2,2-difluoro-propane; and combinations thereof.

As noted above, in one or more embodiments, the cavitation nuclei may be porous nanoparticles. FIG. 2 depicts a porous nanoparticle 2005, in accordance with one or more embodiments. The porous nanoparticle may have pores 2010. The pores 2010 may be micropores or mesopores. Micropores may have a pore size of up to 2 nm. The mesopores may have a pore size ranging from 2 to 50 nm. The porous nanoparticle 2005 may have a size range of 100 to 800 nm. Non-limiting examples of the porous nanoparticle may include silicates, silica-titania particles, organic aerogels, inorganic aerogels, activated carbons, zeolites, and combinations thereof.

In one or more embodiments, the porous nanoparticle 2005 may be made by various methods known in the art. For example, the porous nanoparticle 2005 may be made via a mini-emulsion method. The mini-emulsion method may include a W/O emulsion with n-hexane/n-heptane (oil phase) and water (water phase). The water microdroplets may be surrounded by a monolayer of surfactant in a continuous hydrocarbon phase which may act as micro-reactors to synthesize nanoparticles. The growth of the nanoparticles is controlled inside the water droplet, giving rise to a narrow scale size distribution. In one example, mesoporous silica-titania nanoparticles (MSTNPs) are prepared by incorporating TiO₂ nanoparticles into colloidal mesoporous nanoparticles. In this particular example, the surfactant may be sodium dioctyl sulfosuccinate (AOT). To obtain the TiO₂ nanoparticles, HCl and n-hexane may be removed by evaporation under vacuum. A white compound formed by the titania nanoparticles surrounded by AOT may be obtained. Then, the material may be calcined for 7 hours at 540° C. with air flux. To obtain the mesoporous material, tetraethyl orthosilicate (TEOS) may be mixed with water and stirred. Then NaOH solution may be added drop to drop to the TEOS solution under stirring. To produce the mesoporous material, a solution of didodecyldimethylammonium bromide (DDAB) in water may be added 1 minute after the addition of the NaOH solution. The resulting gel may be stirred for 3 minutes and then left for 48 hours in an autoclave at 100° C., Then, the gel may be filtered and washed with distilled water and left to dry at room temperature. Finally, it may be calcined for 7 hours at 540° C. in an air flux.

In accordance with one or more embodiments, the porous nanoparticle 2005 may contain the gas or the gas precursor as described above. The gas or the gas precursor may be encapsulated in the pores 2010 of the porous nanoparticle 2005. The gas precursor may be encapsulated in the pores 2010 of the porous nanoparticle 2005 by an ultrasonic emulsification method under a temperature below the boiling point of the gas precursor. In such embodiments, the porous nanoparticle 2005 is dispersed in deionized water. The required amount of gas precursor is added to the solution, then the colloidal solution is sonicated. The droplets of the gas precursor are thereby loaded to the pores 2010 of the porous nanoparticle 2005. The porous nanoparticles 2005 may be stored at temperatures below 0° C. to prevent the gas precursor evaporation from the pores 2010.

As depicted in FIG. 2, gas bubbles 2020 may be released from the pores 2010. Releasing gas bubbles 2020 from the gas entrapped in the porous particle may occur due to an interaction with acoustic waves from an acoustic device as explained in greater detail below, or it may occur due to an increase in temperature from the downhole environment.

In one or more embodiments, the cavitation nuclei may be microcapsules. For the purposes of this application, the terms “microcapsule” and “core-shell particle” are used interchangeably and may be understood to mean that the microcapsule or core/shell particle includes an outer layer or “shell” and an inner portion, or “core,” surrounded by the shell. FIG. 3 depicts a microcapsule 3000, in accordance with one or more embodiments. The microcapsule 3000 has a shell 3010 and a core 3020. Gas or gas precursor 3030 is located inside the core 3020. The microcapsule 3000 may have a diameter from 50 microns to 1 mm.

In one or more embodiments, the microcapsule may be made via an emulsion polymerization. In such embodiments, the microcapsule 3000 may be created by generating an emulsion including a monomer-containing phase and a gas precursor-containing phase. The term “emulsion” is used to describe a fine dispersion of one liquid in another in which it is not soluble or miscible. The term emulsion, as used herein, includes microemulsion, mini-emulsion, normal emulsions, and suspensions. The emulsion may be a discontinuous internal oil phase in a continuous water phase (O/W) or an internal water phase in a continuous oil phase (W/O) or an internal oil phase in a continuous oil phase (O/O). The emulsion may have an internal phase of a dispersion, thus a W/O/W, O/W/O, or O/O/W type of emulsion. According to one or more embodiments, the monomer-containing phase is the continuous phase in the emulsion and the discontinuous/internal phase contains the gas precursor.

The monomer-containing phase may be polymerized to form the shell 3010. In one or more embodiments, the monomer-containing phase is the continuous phase in the emulsion. Polymerization may be addition polymerization or condensation polymerization. Addition polymerization may include the polymerization of vinyl monomers. Non-limiting examples of vinyl monomers include acrylamide, acrylic acid, acrylic esters, methacrylic acid, methacrylic esters, styrene, 4-vinylbenzyl chloride, divinylbenzene, and methylenebisacrylamide. Non-limiting examples of polymers that may result from condensation polymerization include melamine-formaldehyde resin, phenol-formaldehyde resin, urea-formaldehyde resin, epoxy resin, urethane/urea resin, and polyester resin. The shell 3010 of the microcapsule 3000 may further include a polymer that can be an addition polymer or a condensation polymer. Examples of the addition polymer include a polyurethane, a polyacrylate, a polyacrylate based copolymer, functionalized polystyrene derivatives, a polyvinyl alcohol, an ethylene-vinylacetate copolymer, a polyacrylamide, a polyacrylamide based copolymer, a polyacrylic acid, a polyacrylic acid based copolymer, a polyolefin, propylene-acrylate copolymer, propylene-methacrylate copolymers, oxidized polypropylene, oxidized polyethylene, propylene-ethylene oxide copolymers, styrene-acrylate copolymers and acrylonitrile-butadiene-styrene copolymers, polypropylene-polyethylene copolymers, polystyrene. Examples of condensation polymers include a polyamide, a polyester, polysiloxane, cellulose, a cellulose derivative, starch or a starch derivative, melamine-formaldehyde, a urea-formaldehyde, a phenol-formaldehyde resin, a melamine-phenol-formaldehyde resin, a furan-formaldehyde resin, an epoxy resin, a polyether, a polyimide, a gelatin, a gelatin derivative, a maleic-anhydride based copolymer, a polyvinylpyrrolidone, a polyvinylpyrrolidone based copolymer, poly[D,L-lactide-co-glycolide], poly(butyl-2-cyanoacrylate), poly(lactic acid), poly(caprolactone), poly(allylamine hydrochloride), and a poly(styrene sulfonate).

In accordance with one or more embodiments, polymerizing the monomer-containing phase of the microcapsule 3000 to form a shell 3010 thereby creates a care 3020. Gas precursor 3030 is located in the core 3020. Examples of the gas precursor have been previously described. For example, a first oil-in-oil emulsion with the monomer-containing phase as the continuous oil phase and the gas precursor-containing phase as the internal oil phase may be prepared using conventional techniques such as agitation, sonication, stirring, or other forms of mixing (e.g. high shear mixing) in the presence of polymeric surfactant block copolymers (BCPs) (such as poly(styrene)-block-poly(pentafluorostyrene), poly(isoprene(-block-poly(ethylene oxide), or solid (Pickering) particles with a desired surface functionality (such as hydrophobic silica or organophilic clay). The weight ratio between the monomer-containing phase and the gas precursor-containing phase may be in a range from 55:45 wt % to 80:20 wt % of the monomer-containing phase to the gas precursor-containing phase. The first oil-in-oil emulsion may form the care 3020 of the microcapsule 3000.

A second emulsion may be used to form the shell 1010 of the microcapsule 3000. The second emulsion may include the first oil-in-oil emulsion as the internal phase and water with stabilizers. The stabilizers may include water-soluble surfactants. Examples of water-soluble surfactants include Tween®20 and Tween®80. The stabilizers may also include water-soluble polymers. Examples of water-soluble polymers may include guar gum and xanthan gum. The second emulsion may be formed using conventional techniques known in the art such as agitation, sonication, stirring, or other forms of mixing. The weight ratio between the first emulsion and the water-phase may be in a range from 15:85 wt % to 40:60 wt % of the first emulsion to the water-phase. After obtaining the stable emulsion, a crosslinking agent may be added to the system, Crosslinking agents may include any crosslinking agent known in the art. Crosslinking of the second emulsion may form the shell 3010 of the microcapsule 3000.

In one or more embodiments, the cavitation nuclei may be a second and different type of core-shell particle. The second core-shell particle may be formed via layer-by-layer deposition. In such embodiments, creating the second core-shell particle may include generating an emmission of a gas and a surfactant. The gas may be air, CO₂, or N₂. The surfactant may be selected from the group of block copolymers of polyoxypropylene and polyoxyethylene (poloxamers), polyoxyethylenesorbitans, polyoxyethylenesorbitan monooleate, sorbitan laurate, sorbitan oleate, polyethylene glycol stearate, glycerol-polyalkylene stearate, glycerol polyoxyethylene ricinoleate, homo- and copolymers of polyalkylene glycols, ethers, esters of fatty acids, and combinations thereof.

Methods of generating the emulsion may include sonication. To form the emulsion, a suspension of bubbles may be created by sonication of the gas in an aqueous solution that includes one of the aforementioned surfactants. The surfactant concentration may be in a range of 0.01 to 5 wt %. The gas flow rate during sonication may be in the range of 0.5 to 10 mL/min.

Creating the shell of the second core shell particle may include depositing polyelectrolytes on the surface of the emulsion. The deposition is achieved by using layer-by-layer deposition based on forming layers of polyelectrolytes with alternating charges. For example, when a mixture of Tween:Span (i.e., polyoxyethylenesorbitan monooleate and sorbitan oleate) surfactants is used as the surfactant and air is used as the gas, the surface charge of the air microbubbles is slightly negative. Poly(allylamine hydrochloride) (PAH) and poly(styrene sulfonate) (PSS) layers are adsorbed in alternation starting from a negatively charged PSS layer and alternating with a positively charged PAH layer until ending with a negatively charged PSS layer. In one or embodiments, three layers of polyelectrolyte are adsorbed. The polyelectrolyte may be selected from the group of poly(allylamine hydrochloride), poly(styrene sulfonate), polyacrylic acid, polyethylenimine, poly(diallyldimethylammonium chloride), and combinations thereof. The polyelectrolyte solutions may be dissolved in an aqueous solution. The polyelectrolyte solutions may have a concentration in a range of 0.5 to 5 mg/mL. Sodium chloride may be added to stabilize charge repulsions in the polyelectrolyte solution. The pH range of the polyelectrolyte solution may be in a range of 4 to 6. Depositing the polyelectrolytes on the surface of the emulsion may generate the cote-shell particle. The gas may be in the core of the core-shell particle. The resulting core-shell particle with entrapped air may be less dense than water and collected easily at the top of the solution upon centrifugation at low rpm.

In one or more embodiments, creating the cavitation nuclei may include creating a third and different core-shell particle. Creating the third core-shell particle may include generating an emulsion. The emulsion may include a volatile organic phase and an aqueous phase. The volatile organic phase may include a polymer. The polymer may be selected from the group consisting of a melamine-formaldehyde, a urea-formaldehyde, a phenol-formaldehyde resin, a melamine-phenol-formaldehyde resin, a furan-formaldehyde resin, an epoxy resin, a polysiloxane, a polyacrylate, a polyester, a polyurethane, a polyamide, a polyether, a polyimide, a polyolefin, polypropylene-polyethylene copolymers, polystyrene, functionalized polystyrene derivatives, gelatin, a gelatin derivative, cellulose, a cellulose derivative, starch or a starch derivative, a polyvinyl alcohol, an ethylene-vinylacetate copolymer, a maleic-anhydride based copolymer, a polyacrylamide, a polyacrylamide based copolymer, a polyacrylic acid, a polyacrylic acid based copolymer, a polyvinylpyrrolidone, a polyvinylpyrrolidone based copolymer, a polyacrylate based copolymer, a polyacrylamide, a polyacrylamide based copolymer, propylene-acrylate copolymer, propylene-methacrylate copolymers, oxidized polypropylene, oxidized polyethylene, propylene-ethylene oxide copolymers, styrene-acrylate copolymers and acrylonitrile-butadiene-styrene copolymers, poly[D,L-lactide-co-glycolide], poly(butyl-2-cyanoacrylate), poly(lactic acid), poly(caprolactone), poly(allylamine hydrochloride) and poly(styrene sulfonate), and mixtures thereof.

The volatile organic phase may include a surfactant. In one or more embodiments, the surfactant stabilizes the emulsion. The surfactant may be selected from the group consisting of free fatty acids, esters of fatty acids with polyoxyalkylene compounds like polyoxypropylene glycol and polyoxyethylene glycol; ethers of fatty alcohols with polyoxyalkylene glycols; esters of fatty acids with polyoxyalkylated sorbitan; soaps; glycerol-polyalkylene stearate; glycerol-polyoxyethylene ricinoleate; homo- and copolymers of polyalkylene glycols; polyethoxylated soya-oil and castor oil as well as hydrogenated derivatives; ethers and esters of sucrose or other carbohydrates with fatty acids, fatty alcohols, these being optionally polyoxyalkylated; mono-, di- and triglycerides of saturated or unsaturated fatty acids; and glycerides or soya-oil. The surfactant may be added to the volatile organic phase at a concentration in the range of 0.1 to 5 wt %.

The volatile organic phase may include a volatile organic solvent. The volatile organic solvent may be any known volatile organic solvent in the art, such as tetrahydrofuran, cyclohexane, acetone, ethyl acetate, dichloromethane, hexane, heptane, n-octane, cyclooctane, the dimethylcyclohexanes, ethyl-cyclohexane, 2-, 3- and 4-methyl-heptane, 3-ethyl-hexane, toluene, xylene, 2-methyl-2-heptane, 2,2,3,3-tetramethylbutane, esters such as propyl and isopropyl butyrate and isobutyrate, butyl-formate, halogenated compounds such as CCl₄, CH₃Br, CH₂Cl₂, chloroform, low boiling esters such as methyl, ethyl and propyl acetate as well as lower ethers and ketones of low water solubility. The aqueous phase may be water.

In accordance with one or more embodiments, creating the third core-shell particle may include evaporating the volatile organic solvent so that the polymer will deposit by interfacial precipitation around the droplets. The core-shell particle may form with a core of hydrophobic phase encapsulated by a polymer. The obtained core-shell particles form a suspension in a water phase. The evaporation of hydrophobic phase may be performed at a temperature where the partial vapor pressure of the hydrophobic phase is of the same order as that of water vapor.

Creating the third core-shell particle may further include subjecting the suspension of core-shell particles to freeze-drying conditions, known as lyophilzation. Lyophilizing may be done where the hydrophobic phase is selected so that it evaporates simultaneously with the aqueous phase and is replaced by air or gas. Lyophilizing may occur at temperatures from −0° C. to 40° C. under a vacuum of about 1 Torr. The gas may be air, CO₂ or N₂. Lyophilizing may produce dry, free flowing, readily dispersible core-shell particles with gas in the core.

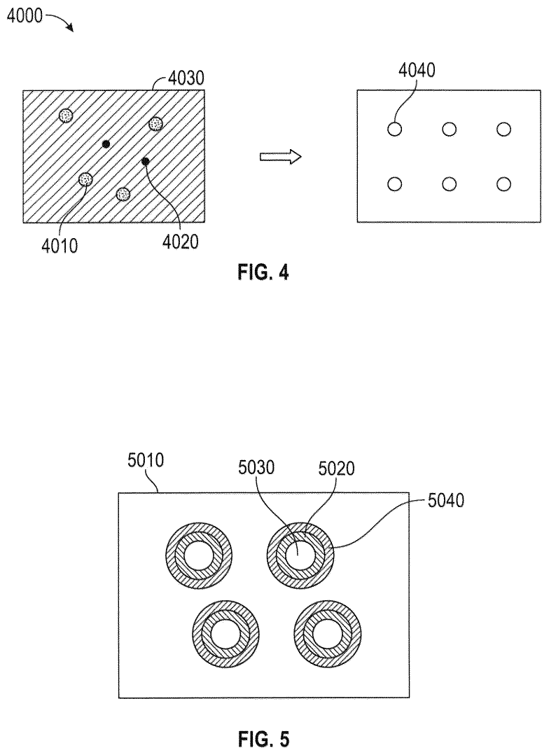

In one or more embodiments, cavitation nuclei may be created using a gas generating system in which an acidic component and a basic component can be combined to form a gas downhole. FIG. 4 depicts a gas generating system 4000. The gas generating system 4000 may include a first microcapsule 4010. The shell of the first microcapsule 4010 may be crosslinked vegetable oils, natural and synthetic polymers (such as polyvinylchloride, nylon, acrylic resin polymers, cellulose acetate phthalate, carboxylated polymers, UV-curable acrylate monomers), polyurethane, polyurea, or nanoparticles such hydrophobic nanosilica.

The first microcapsule 4010 has a core. The shell of the first microcapsule may encapsulate the core. The method of encapsulation may include in-situ polymerization, interfacial polymerization, complex coacervation, polymer/polymer phase separation, UV polymerization, or other suitable forms of encapsulation. The core of the first microcapsule 4010 includes an acid. The acid may be an organic acid. The organic acid may be selected from the group including lactic acid, acetic acid, formic acid, citric acid, oxalic acid, and combinations thereof. The acid may be a mineral acid. The mineral acid may be selected from the group including hydrochloric acid, hydrofluoric acid, nitric acid, and combinations thereof. The acid may be dissolved in an aqueous solution at a concentration in a range from 10 to 15 wt %.

The method of encapsulating the core by the shell of the first microcapsule 4010 depends on the type of acid in the core, as well as the requirements for stability under downhole conditions and the type of carrier fluid. For example, when the core is hydrochloric acid, hydrophobic silica nanoparticles may be used as a shell. In such embodiments, the method of encapsulation may involve blending the hydrophobic silica and aqueous hydrochloric acid solution in a ratio of 1:10 by weight constant speed of 16,000 rpm for 60 seconds. Blending may result in the formation of water-in-air (or acid-in-air) powders with hydrochloric acid solution completely encapsulated inside the silica shell. These powders are referred as “acid-in-air powders” or “dry acids.” In other embodiments, a method of hydrochloric acid encapsulation is water-in-oil-in-water double emulsion preparation with an ultraviolet-light curing system that creates a shell.

The gas generating system includes a second microcapsule 4020. The shell of the second microcapsule 4020 may be hydrophilic organic polymers, hydrophobic organic polymers, and mixtures thereof. Examples of hydrophilic organic polymers may include gum arabic, gum karaya, gum tragacanth, guar gum, locust bean gum, xanthan gum, carrageenan, alginate salt, casein, dextran, pectin, agar, sorbitol, 2-hydroxyethyl starch, 2-aminoethyl starch, maltodextrin, amylodextrin, 2-hydroxyethyl cellulose, methyl cellulose, carboxymethyl cellulose salt, cellulose sulfate salt, polyvinylpyrrolidone, polyethylene glycol, polypropylene glycol, polyethylene oxide, and polyvinyl alcohol. Examples of hydrophobic organic polymers may include polyvinyl acetate, polyacrylamide, polyvinyl chloride, polystyrene, polyethylene, polyurethane. In some embodiments, both a hydrophilic organic polymer and a hydrophobic organic polymer are included in the shell of the second microcapsule 4020. The hydrophilicity of the hydrophilic organic polymer may be tied by the addition of the hydrophobic organic polymer. The amount of tuning may depend on the desired level of hydrophilicity.

The second microcapsule 4020 may include a core. The core may include a base. The base may be encapsulated by suitable means known in the art, such as pan coating, fluidized coating. Wurster process, and centrifugal fluidized coating. For example, the polymer may be dissolved in a suitable solvent such as water, methanol, ethanol, acetone, tetrahydrofuran, ethyl acetate, or dimethylformamide, as appropriate to dissolve a selected polymer species. The polymer also may be in the form of an emulsion or suspension. After the polymer is applied to the particles, the solvent may be removed by evaporation, thereby forming a continuous film coating which encapsulates the discrete base particles. For example, a Wurster process using a Wurster air-suspension coater system has compressed air introduced into the coating chamber. The polymeric solution is sprayed on the air-suspended base particles, until the coating weight is about 5-50% of the total dry weight of the microcapsules. The base may be a carbonate or bicarbonate. The carbonate or bicarbonate may be an alkali metal, alkaline earth metal, ammonium carbonate, and combinations thereof. The amount of base in the microcapsules may be about 50 to 95 wt %.

The first microcapsule 4010 and second microcapsule 4020 may be mixed in a fluid 4030. Rupturing the first microcapsule 4010 and the second microcapsule 4020 may create gas bubbles 4040. Rupturing may occur by a change in pressure done mechanically or by a change in temperature. Pressure and temperature requirements are determined by the type of shell of the microcapsules. The pressure required may be in a range from 5 to 90 MPa. The temperature required may be in a range from 80 to 25° C. Rupturing may occur due to hydrostatic pressure in the well. Rupturing may also occur due to applying squeezing pressure after placing, for example, a lost circulation material with a gas generating system in the well. The gas bubbles 4040 may be created by a reaction of the acid and the base. The gas bubbles 4040 may include carbon dioxide gas.

In accordance with one or more embodiments, the first microcapsule 4010 may include ammonium nitrate. In such embodiments, the second microcapsule may contain metal hydrides or sodium nitrite. In these embodiments, rupturing the first microcapsule 4010 and the second microcapsule 4020 may create N₂ gas bubbles 4040. The encapsulation methods and concentrations for the ammonium nitrate and metal hydrides or sodium nitrate are the same as previously described for the acid and base.

Another method for creating cavitation nuclei includes the use of an encapsulated foam generating compound with the gas generating system described previously. In such embodiments, a foam generating compound may be encapsulated in a microcapsule. The shell of the microcapsule may be a mesoporous material, such as silica particles. Methods to synthesize mesoporous silica particles include the sot-gel method, microwave assisted technique, chemical etching technique, and the templating approach. In the templating approach, a template (i.e., a structure directing agent) may be used to a create hollow porous structure. In the chemical etching technique, a selective etching agent (i.e., an acid or a base) may be used to create a mesoporous structure. In the chemical etching technique, a template (either soft or had) is not required. The microwave assisted technique may be used for a rapid synthesis of mesoporous silica nanoparticles. In the microwave assisted technique, self-assembly of organosilane precursors and block copolymers with a successive hydrothermal treatment may be carried out under a microwave oven. Commercially available silica particles way include MCM-41 and MCM-48.

The core of the microcapsule includes the foam generating compound. The foam generating compound may be a nonionic, anionic, cationic, zwitterionic foaming surfactants, and mixtures thereof. The surfactant may act as both a foam generating compound and a template for formation of the mesoporous shell. Incorporation of the surfactant as a template for the mesoporous shell may require careful selection of the silica precursor and modification of the reaction conditions. For example, in the case of an anionic surfactant, (3-aminopropyl) triethoxysilane (APTES) is added along with tetraethyl orthosilicate (TEOS) as a silica precursor. The presence of a positively charged group on APTES provides the anchor group for interactions with the negatively charged surfactant molecules. Non-limiting examples of the foam generating compounds may include ethoxylated and propoxylated alcohols and phenols; polyalkoxylated fatty acid esters and amides, alkyl sulfonates; alkyl sulfates and alkyl ether sulfates; mono- and dialkyl sulfosuccinates; generally quaternary ammonium salts, amine oxides; alkyl betaines and sulfobetaines; alkylamido betaines and sulfobetaines.

In accordance with one or more embodiments, the microcapsules including the foam generating compound are mixed with a drilling fluid. The drilling fluid is any known drilling fluid in the art. Rupturing the microcapsule with the foam generating compound in the core may produce a foam. Rupturing may occur by interaction of the microcapsules with an acoustic field, as explained below. Rupturing may also occur by a change in pressure done mechanically or by a change in temperature. Pressure and temperature requirements are determined by the type of shell of the microcapsules. The pressure required may be in a range from 2 to 70 MPa. The temperature required may be in a range from 60 to 200° C. Rupturing may occur due to hydrostatic pressure in the well. Rupturing may also occur due to applying squeezing pressure after placing, for example, a lost circulation material with a gas generating system and a roam generating compound in the well. In one or more embodiments, the foam is produced from the interaction of the foam generating compound with the gas generating system in the drilling fluid. The components of the gas generating system react with each other to produce gas bubbles. The foam generating compound adsorbs on the gas/liquid interface and reduces the surface tension, stabilizes the gas bubbles, and produces the foam. The foam may contain gas bubbles. The gas bubbles may be air, CO₂ or N₂.

In one or more embodiments, the method of the present disclosure may also include creating a stabilized fluid for the cavitation nuclei. A stabilized fluid is present to deliver the cavitation nuclei downhole and prevent them from rupturing prior to arriving at the desired location where cavitation will occur. The cavitation nuclei may be prone to rupture or undergo cavitation if they are not adequately stabilized, thus the stabilized fluid. FIG. 5 depicts a stabilized fluid 5010 in accordance with one or more embodiments. The stabilized fluid may include a surfactant 5020, a viscosity enhancer (not shown), gas bubbles 5030, and a second surfactant 5040. The stabilized fluid 5010 is a carrier fluid that may be aqueous or non-aqueous and includes additives for gas bubble stabilization. The additives may include the surfactant 5020, the viscosity enhancer, and the second surfactant 5040.

The surfactant 5020 of the stabilized fluid of one or more embodiments may be film forming. The stabilized fluid 5010 may be an aqueous or non-aqueous suspension in which the bubbles of gas are bound at the gas/liquid interface by a very thin film of a surfactant 5020. The surfactant 5020 may be a stabilizing amphiphilic surfactant. The surfactant 5020 may spontaneously adsorb from soluble aggregates (i.e., micelles and vesicles) to the gas-liquid interface and self-assemble into a monolayer coating (i.e., a film). At the nanoscale, the molecules are oriented such that the hydrophobic tails adsorb to the gas phase and interact via hydrophobic and dispersion forces, which may be modulated by increasing or decreasing chain length. The film protects the gas bubbles from collapse. The method for preparing the stabilized fluid 5010 with the surfactant 5020 as cavitation nuclei may include generating a gas microbubble dispersion by submitting an aqueous or non-aqueous medium comprising an amphiphilic film-forming compound and additives to a controlled agitation in the presence of a desired gas. The surfactant may be cationic, anionic, or non-ionic. Examples of the surfactant include block copolymers of polyoxypropylene and polyoxyethylene (poloxamers), polyoxyethylenesorbitans, glycerol-polyalkylene stearate, glycerolpolyoxyethylene ricinoleate, homo- and copolymers of polyakylene glycols, ethers and esters of fatty acids, and combinations thereof. The surfactant may also include non-film forming amphiphilic compounds of the type of polyethylene dodecanoate. The concentration of the surfactant 5020 may be in a range of 0.01% to 10 wt %.

The film forming surfactant 5020 may create a monolayer film. The film forming surfactant 5020 may also create a bilayer film. The number of layers may be controlled by the concentration of the surfactant 5020, conditions of the preparation, type and amount of additives (e.g. viscosity enhancers, non-film forming surfactants, electrolytes etc.), and temperature. The bilayer film may be in lamellar form. The bilayer film may be created via high pressure homogenization or sonication. For example, a stabilized fluid 5010 with bilayers may be created in a high pressure homogenizer at 500 to 800 bar in 3 to 10 cycles of homogenization. For sonication, a water bath sonicator may be used for the bilayer film formation at a 50% duty cycle for 1 minute per mL of the fluid.

The stabilized fluid 5010 may also include a viscosity enhancer. The viscosity enhancer may form an additional film around the surfactant 5020, giving the stabilized fluid additional stability. The viscosity enhancer may be selected from the group of water-soluble polymers, including polysaccharide, polyorthoester, polyaminoacid, polyacrylamide, a chitosan and from a group of oil-soluble polymers, including polyester, polyolefins, polyethylene, and mixtures thereof. The surfactant and the viscosity enhancer may be mixed to form a fluid mixture. The gas may be introduced into the stabilized fluid 5010 by several techniques including injection, sonication in the presence of gas, or spinning of a disc type generator. In each technique, the surfactant 5020 and viscosity enhancer may be mixed then the gas is introduced. For an example when sonication is used, the conditions may include sonicating for 1 to 30 minutes with 50 to 500 watts of power where the tip of the sonotrode may be placed at the liquid-air interface. The agitator may include a 3 centimeter diameter spinning disk mounted at the end of a shaft connected to an electrical motor. The stabilized fluid may be homogenized for 60 to 360 seconds at the speed of 5,000 to 10,000 rpm. The concentration of the viscosity enhancer may be in a range of 1 to 40 wt %. In some embodiments, the concentration of the viscosity enhancer is in a range of 3 to 20 wt %.

The stabilized fluid may include cavitation nuclei. The cavitation nuclei may be as previously described. The cavitation nuclei include gas bubbles 5030 and may be incorporated by sonicating the cavitation nuclei with the stabilized fluid mixture. Sonicating may occur at acoustic or ultrasonic frequencies. The bubbles 5030 of the cavitation nuclei may have diameters from 200 nm to 100 μm.

In accordance with one or more embodiments, the stabilized fluid may further include an outermost layer with a second surfactant 5040. The second surfactant may make the stabilized fluid compatible with a drilling fluid. The second surfactant may be cationic, anionic, non-ionic, or zwitterionic. The second surfactant 5040 may improve the compatibility of the stabilized fluid 5010 with the drilling fluid because positively charged gas microbubbles may destabilize water-based drilling fluids containing negatively charged polymers such as polyanionic cellulose. As a result, nonionic or anionic surfactants, such as ethoxylated phenols or sodium dodecyl sulfate, may be utilized as the second surfactant 5040. The concentration of the second surfactant may be about 1 wt %.

### Method of Inducing Cavitation

Embodiments of the present disclosure relate to a method of treating a well environment. As noted above, the method includes creating cavitation nuclei, introducing cavitation nuclei to a drilling fluid, delivering the drilling fluid downhole, and activating an acoustic device downhole thereby inducing cavitation downhole. Creating cavitation nuclei may include any of the methods described above.

The method of treating a well environment may include introducing the cavitation nuclei to a drilling fluid to deliver the cavitation nuclei to the downhole environment and specifically to the treatment area. For the purposes of this application, the terms “wellbore fluid” and “drilling fluid” are used interchangeably. In one or more embodiments, the drilling fluid includes an aqueous-based fluid. The aqueous-based fluid includes water. The water may be distilled water, deionized water, tap water, fresh water from surface or subsurface sources, production water, formation water, natural and synthetic brines, brackish water, natural and synthetic sea water, black water, brown water, gray water, blue water, potable water, non-potable water, other waters and combinations thereof that are suitable for use in a wellbore environment, that is, the contaminants do not interfere with the function of the drilling fluid. In one or more embodiments, the water used may naturally contain contaminants, such as salts, ions, minerals, organics, and combinations thereof, as long as the contaminants do not interfere with the function of the drilling fluid.

The drilling fluid may contain water in a range of from about 50 to 97 wt % (weight percent) based on the total weight of the drilling fluid. In one or more embodiments, the embodiment drilling fluid may comprise greater than 70 wt % water based on the total weight of the drilling fluid.

In one or more embodiments, the water used for the drilling fluid may have an elevated level of salts or ions versus fresh water, such as salts or ions that are naturally present, such as in formation water, production water, seawater, and brines. In one or more embodiments, salts or ions are added to the water used to increase the level of a salt or ion in the water to effect certain properties, such as density of the drilling fluid or to mitigate the swelling of clays that come into contact with the drilling fluid, such as in “synthetic” brines and seawaters. Increasing the salutation of water by increasing the salt concentration or other organic compound concentration in the water may increase the density of the water, and thus, the drilling fluid. Suitable salts may include, but are not limited to, alkali metal halides, such as chlorides, hydroxides, or carboxylates. In one or more embodiments, salts included as part of the aqueous-based fluid may include salts that disassociate into ions of sodium, calcium, cesium, zinc, aluminum, magnesium, potassium, strontium, silicon, lithium, chlorides, bromides, carbonates, iodides, chlorates, bromates, formates, nitrates, sulfates, phosphates, oxides, and fluorides, and combinations thereof. Brines may be used to create osmotic balance between the drilling fluid and portions of the subterranean formation. Salts present in aqueous-based drilling fluids may affect the electrostatic interactions between the polymers described here and the surface of tools used in drilling.

In one or more embodiments, the drilling fluid may comprise one or more salts in an amount that ranges from about 1 to 300 ppb (pounds per barrel). For example, the drilling fluid may contain the one or more salts in an amount ranging from a lower limit of any of 1, 10, 50, 80, 100, 120, 150, 180, 200, 250, and 280 ppb to an upper limit of any of 20, 30, 40, 50, 70, 100, 120, 150, 180, 200, 220, 240, 260, 280, and 300 ppb, where any lower limit can be used in combination with any mathematically-compatible upper limit.

In one or more embodiments, the drilling fluid may include at least one pH adjuster. The drilling fluid composition may optionally include at least one alkali compound. Examples of alkali compounds may include, but are not limited to, lime (calcium hydroxide, calcium oxide, or a mixture thereof), soda ash (sodium carbonate), sodium hydroxide, potassium hydroxide, and combinations thereof. The alkali compounds may react with gases, such as CO₂ or H₂S (also known as acid gases), encountered by the drilling fluid composition during drilling operations to prevent the gases from hydrolyzing components of the drilling fluid composition. In one or more embodiments, the drilling fluid compositions may optionally include having a pH adjuster in a range of from about 0.01 wt % to 0.7 wt %, such as from 0.01 wt % to 0.5 wt %, from 0.01 wt % to 0.3 wt %, from 0.01 wt % to 0.1 wt %, from 0.01 wt % to 0.05 wt %, from 0.05 wt % to 0.7 wt %, from 0.05 wt % to 0.5 wt %, from 0.05 wt % to 0.3 wt %, from 0.05 wt % to 0.1 wt %, from 0.1 wt % to 0.7 wt %, from 0.1 wt % to 0.5 wt %, from 0.1 wt % to 0.3 wt %, from 0.3 wt % to 0.7 wt %, from 0.3 wt % to 0.5 wt %, or from 0.5 wt % to 0.7 wt % pH adjuster based on the total weight of the drilling fluid composition. Some drilling fluid compositions may optionally include in a range of from about 0.01 ppb to 10 ppb of at least one pH adjuster based on the total volume of the drilling fluid composition.

The drilling fluid may have a neutral or alkaline pH. In one or more embodiments, the drilling fluid may have a pH in a range of from about 7 to 11, such as from about 7, 7.5, 8, 8.5, 9, 9.5, and 10 to about 7.5, 8, 8.5, 9, 9.5, 10, 10.5, and 11, where any lower limit may be combined with any mathematically feasible upper limit.

The drilling fluid may optionally include a polymer. The polymer may act as a carrier fluid to deliver the cavitation nuclei downhole. The polymer may be a water soluble biopolymer (e.g., xanthan gum or guar gum) or a synthetic polymer (e.g., polyacrylamide).

In one or more embodiments, the cavitation nuclei may be introduced into the drilling fluid prior to the drilling fluid being delivered downhole. The drilling fluid may be circulating through the wellbore and processed through the wellbore circulation system on the surface. In one or more embodiments, the cavitation nuclei may be introduced into the wellbore fluid at the surface. In FIG. 1, for example, the cavitation nuclei may be introduced into the wellbore fluid 1032 at the surface 1010 using the cavitation nuclei injection line 1050 through mud return line 1044. The cavitation nuclei may be introduced in the drilling fluid in an amount ranging from 0.05 to 1 wt %.

In one or more embodiments, the cavitation nuclei may be introduced into the wellbore before the drilling fluid. The drilling fluid may be added into the wellbore after the cavitation nuclei. In FIG. 1, for example, the cavitation nuclei may be introduced at the surface 1010 using the cavitation nuclei injection line 1050 before the wellbore fluid 1032 being introduced.

The method of treating a well environment may include delivering the drilling fluid downhole. The method may further include delivering the cavitation nuclei downhole. As previously described, the cavitation nuclei may be mixed with the drilling fluid, added before the drilling fluid, or added after the drilling fluid. As described in FIG. 1, the wellbore fluid 1032 typically flows downhole through an internal fluid conduit of the drill string 1026. Delivering the drilling fluid downhole may include a pump. The pump may include any suitable known pump for well environments.

Once the cavitation nuclei have been introduced to the downhole environment, the method of treating a well environment may include activating an acoustic device downhole thereby inducing cavitation via the cavitation nuclei downhole. The well environment downhole may include elevated temperatures and elevated pressures. Elevated in the context of temperature and pressure means greater than room temperature and pressure, respectively. The temperature of the well environment downhole may be as high as 500° C. and may be lower than 5° C. The temperature of the well environment downhole may depend on the field, on the geothermal gradient, and the depth. The pressure of the well environment downhole may be as high as 100 MPa and lower than 10 MPa. The pressure of the well environment downhole may depend on the field, on the geothermal gradient, and the depth. The cavitation nuclei described herein may be designed to induce cavitation at these elevated temperatures and pressures.

As shown in FIG. 1, the treatment system includes a treatment sub 2000. The treatment sub 2000 may include an acoustic source. The acoustic source may generate suitable frequencies to induce cavitation. The frequencies may be in the range from 1 to 500 kHz. The frequencies may create an acoustic field. The acoustic field may interact with the cavitation nuclei and induce cavitation.

In one or more embodiments, the acoustic source may be configured to generate a single frequency. However, as is understood by those skilled in the at, even a single frequency generally includes a narrow range of frequencies. Thus, as used herein, “a single frequency” generally refers to a narrow spectrum of acoustic frequencies. In one or more embodiments, the acoustic source is configured to generate acoustic frequency at multiple frequencies. In one or more embodiments, the acoustic source is configured to generate a single type of acoustic frequency at multiple frequencies sequentially. For example, the acoustic source may generate an ultrasonic frequency comprised of a first single frequency during a first period and then alternate to a second single frequency during a second period. In one or more embodiments, the acoustic source is configured to generate multiple frequencies simultaneously. In such configurations, the periods may be very short to cause oscillations in the patterns in the frequency. For example, an acoustic source may generate a frequency comprised of a plurality of acoustic frequencies. In such embodiments, a plurality of acoustic sources may be included and configured in the BHA system to provide the plurality of frequencies. This frequency oscillation may facilitate cavitation a conjunction with the cavitation nuclei.

In one or more embodiments, the acoustic source may be an ultrasonic source. The ultrasonic source may generate frequency. The frequency may be an ultrasonic frequency with a range of from about 20 to 500 kHz, in generating a frequency, cavitation of the wellbore fluid as previously described may occur.

In one or more embodiments, the frequency generated may be a plurality of frequencies. In one or more embodiments, the plurality of frequencies may include an acoustic frequency and an ultrasonic frequency.

Activating the acoustic source downhole and thereby inducing cavitation downhole requires maintaining communication with the acoustic source. In accordance with one or more embodiments, ways of maintaining communications with the acoustic source may include, but are not limited to, a dedicated communication line from the surface coupled to an internally-located communications device, such as control signal line 1046 of FIG. 1, mud pulse telemetry through the wellbore fluid 1032 to an externally-located communication device, and by “smart pipe”, a form of drill pipe with integrated electrical and signal connectors, that may couple with similar integration at the drill pipe connector. In one or more embodiments, mud pulse telemetry is used to maintain communication with the acoustic source and thus, activate the acoustic source downhole. As is known by those skilled in the art, mud pulse telemetry is the use of pressure pulses arranged in a binary code to transmit a signal downhole to a detector. In one or more embodiments, the acoustic source has a detector to receive the pressure pulses, thus maintaining communication with the acoustic source downhole.

Inducing cavitation through cavitation nuclei, according to one or more embodiments, may have an application of curing lost circulation. In other embodiments, inducing cavitation may lead to the activation of microcapsules with a crosslinking agent to polymerize an active medium in water/gas shut-off operations. In even other embodiments, inducing cavitation may have an application in isolation squeeze operations.

### Method for Preventing Lost Circulation

Embodiments of the present disclosure may include a method for preventing lost circulation. The method may include introducing cavitation nuclei downhole, introducing lost circulation materials downhole, activating an acoustic source thereby initiating cavitation, and rupturing the microcapsules of the curing agent to prevent lost circulation. Systems and methods for delivering cavitation nuclei downhole and initiating cavitation with regards to lost circulation have been previously described in International Application No. PCT/US2023013755, which is incorporated by reference herein in its entirety.

In addition to introducing cavitation nuclei downhole as previously described, embodiments of the present disclosure include methods of introducing a lost circulation material downhole. The lost circulation material may include a resin. The lost circulation material may further include a crosslinking agent. The crosslinking agent may be encapsulated in a microcapsule.

In one or more embodiments, the lost circulation material includes a resin. The resin may be any resin suitable for producing a solid lost circulation material (LCM). Such resins may react with a crosslinking agent to form an effective, solid LCM product that may withstand the differential pressure as the LCM material bridges the face of the lost circulation zone (LCZ). In one or more embodiments, the resin is an epoxy resin.

In one or more embodiments, the resin is an epoxide resin. Generally, such epoxide resins are derived from a polyether derivative of a polyhydric organic compound, where the derivation includes a 1,2-epoxy groups and where the polyhydric organic compound includes polyhydric alcohols, polyhydric phenols, and ethers that contain at least two phenolic hydroxy groups.

In one or more embodiments, the lost circulation material includes a crosslinking agent. The crosslinking agent may be any crosslinking agent suitable for producing a solid lost circulation material. As previously described, such crosslinking agents are configured to react with the resin agent to form an LCM product.

In one or more embodiments, the crosslinking agent is an amine type curing agent. Amine type curing agents may include a low molecular weight compound having a primary-, secondary- or tertiary amino group, and combinations thereof. “Low molecular weight” compounds having a primary amino group include, but are not limited to, primary amines, such as ethylenediamine, diethylenetriamine (DETA), triethylenetetramine, tetraethylenepentamine, hexamethylenediamine, isophorone diamine, bis(4-amino-3-methylcyclohexyl)methane, diaminodicyclohexylmethane, m-xylenediamine, diaminodiphenylmethane, diaminodiphenylsulfone, diethyltoluenediamine, polyoxypropylene diamine, and m-phenylenediamine; guanidines, such as dicyandiamide, methylguanidine, ethylguanidine, propylguanidine, butylguanidine, dimethylguanidine, trimethylguanidine, phenylguanidine, diphenylguanidine, and tolylguanidine; acid hydrazides, such as succinic acid dihydrazide, adipic acid dihydrazide, phthalic acid dihydrazide, isophthalic acid dihydrazide, terephthalic acid dihydrazide, p-hydroxybenzoic acid hydrazide, salicylic acid hydrazide, phenylaminopropionic acid hydrazide, and maleic acid dihydrazide.

Low molecular weight compounds having a secondary amino group include, but are not limited to, piperidine, pyrrolidine, diphenylamine, 2-methylimidazole, and 2-ethyl-4-methylimidazole.

Low molecular weight compounds having a tertiary amino group include, but are not limited to, imidazoles, such as 1-cyanoethyl-2-undecylimidazole-trimellitate, imidazolylsuccinic acid, 2-methylimidazole-succinic acid, 2-ethylimidazole-succinic acid, 1-cyanoethyl-2-methylimidazole, 1-cyanoethyl-2-undecylimidazole, and 1-cyanoethyl-2-phenylimidazole.

In one or more embodiments, the crosslinking agent is encapsulated in a microcapsule. The shell of the microcapsule may be capable of being ruptured by a cavitation event.

In one or more embodiments, the resin and crosslinking agent may be mixed with the cavitation nuclei at the surface before introducing downhole. In other embodiments, the cavitation nuclei and LCM may be introduced sequentially. In FIG. 1, for example, the cavitation nuclei and LCM may be introduced at the surface 1010 using the cavitation nuclei injection line 1050. In other embodiments, the cavitation nuclei and LCM may be introduced sequentially using the cavitation nuclei injection line 1050.

The introduction of both the resin and the crosslinking agent into the wellbore fluid may occur simultaneously. The introduction of the resin, crosslinking agent, and cavitation nuclei into the drilling fluid may also occur simultaneously. In one or more embodiments, the introduction of the resin, the crosslinking agent, and the cavitation nuclei into the wellbore fluid may occur sequentially. The drilling fluid with the cavitation nuclei should be miscible with the resin of the lost circulation material for effective activation of the crosslinking agent once released from the microcapsule by cavitation effect.

In one or more embodiments, the method of preventing lost circulation includes rupturing the microcapsules of the crosslinking agent to prevent lost circulation. The rupturing may occur due to a cavitation event from the cavitation nuclei interacting with the acoustic field generated by the acoustic source.

In one or more embodiments, rupturing the microcapsules of crosslinking agent produces a reaction between the crosslinking agent and the resin. The reaction of the crosslinking agent and the resin may form an effective, solid LCM product. The product LCM may be circulated by the flow of the wellbore fluid into the face of the lost circulation zone (LCZ). As the product LCM continues to react and harden into a solid polymer material, the product LCM may settle and stack in the lost circulation zone. This settling and stacking under the influence of differential pressure between the wellbore and the lost circulation zone may fluidically seal the LCZ. Upon formation of the fluidic seal by the LCM product, the lost circulation zone may be mitigated.

Embodiments of the present disclosure may provide at least one of the following advantages. It is known that the threshold to induce cavitation rapidly increases with increasing pressure. This makes it difficult to induce cavitation downhole where pressures are known to be elevated. The embodiments of the present disclosure describe methods of inducing cavitation via cavitation nuclei that are stable under pressures downhole. Thus, embodiments of the present disclosure allow for cavitation to be produced under elevated pressures. The use of cavitation via cavitation nuclei under such conditions is advantageous for applications in lost circulation mitigation, water/gas shut-off operations, and isolation squeeze operations.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method comprising:
creating cavitation nuclei;
introducing cavitation nuclei to a drilling fluid;
delivering the drilling fluid downhole; and
activating an acoustic source downhole thereby inducing cavitation downhole.

2. The method of claim 1, wherein creating cavitation nuclei comprises:
entrapping a gas or gas precursor within pores of a porous nanoparticle.

3. The method or claim 2, wherein the porous nanoparticle contains micropores and mesopores.

4. The method of claim 1, wherein creating cavitation nuclei comprises:
generating an emulsion comprising a monomer-containing phase and a gas precursor-containing phase; and
polymerizing the monomer-containing phase, thereby generating a core-shell particle, wherein the gas precursor is a core of the core-shell particle.

5. The method of claim 4, wherein the monomer-containing phase comprises vinyl monomers.

6. The method of claim 1, wherein creating cavitation nuclei comprises:
generating an emulsion comprising a gas and a surfactant; and
depositing polyelectrolytes layer-by-layer on the emulsion, thereby generating a core-shell particle, wherein the gas is the core of the core-shell particle.

7. The method of claim 6, wherein the polyelectrolyte is selected from the group comprising poly(allylamine hydrochloride), poly(styrene sulfonate), and combinations thereof.

8. The method of claim 1, wherein creating cavitation nuclei comprises:
generating an emulsion comprising a volatile organic phase and an aqueous phase, wherein the volatile organic phase comprises a polymer and a volatile organic solvent;
evaporating the volatile organic solvent, thereby depositing the polymer around the aqueous phase, and generating a core-shell particle; and
lyophilizing the aqueous phase in presence of a gas, thereby encapsulating the gas in the core of the core-shell particle.

9. The method of claim 1, wherein creating cavitation nuclei comprises:
generating a first microcapsule containing an acid;
generating a second microcapsule containing a base, wherein the base is a carbonate compound or bicarbonate compound;
mixing the fast and second microcapsules in a fluid; and
rupturing the first and second microcapsules, thereby mixing the acid and base to generate carbon dioxide gas.

10. The method of claim 9, wherein the acid is an organic acid.

11. The method of claim 9, wherein the acid is a mineral acid.

12. The method of claim 1, wherein creating cavitation nuclei comprises:
generating a microcapsule of a foam generating compound; and
rupturing the microcapsule, thereby producing a foam.

13. The method of claim 1, wherein introducing cavitation nuclei to the drilling fluid occurs after delivering the drilling fluid downhole.

14. The method of claim 1, wherein the acoustic source is an ultrasonic source.

15. The method of claim 14, wherein the ultrasonic source operates at a frequency range of 20 to 500 kHz.

16. The method of claim 1, wherein inducing cavitation downhole occurs at a pressure in the range of 5 to 90 MPa.

17. A method for preventing lost circulation, the method comprising:
introducing cavitation nuclei downhole;
introducing lost circulation materials downhole, wherein the lost circulation materials comprise a resin and microcapsules of a crosslinking agent;
activating an acoustic source thereby inducing cavitation; and
rupturing the microcapsules of the crosslinking agent to prevent lost circulation.
